(19) United States
(12) Patent Application Publication
(10) Pub. No.: US 2016/0110713 A1
(43) Pub. Date: Apr. 21, 2016

(54) METHOD AND SYSTEM FOR SECURE GLOBAL TOKENIZATION

(71) Applicant: MasterCard International Incorporated, Purchase, NY (US)

(72) Inventor: Justin X. HOWE, San Francisco, CA (US)

(21) Appl. No.: 14/519,543

(22) Filed: Oct. 21, 2014

(51) Int. Cl. G06Q 20/40; H04L 9/08

(52) U.S. Cl. CPC G06Q 20/401; H04L 9/0869; H04L 2209/24

(57) ABSTRACT

A method for transmitting tokenized data includes: storing a plurality of token profiles, each profile including data related to a tokenized data element including a token, data value, and associated data element; receiving a transaction message via a payment network, the message being formatted pursuant to one or more standards governing the interchange of transaction messages and including data in one or more data elements reserved for private use in the one or more standards; identifying, for each data elements, a corresponding token profile where the included associated data element is the respective data element and where the included token corresponds to the data included in the respective data element; updating the transaction message by replacing the data included in each of the one or more data elements with the data value included in the identified corresponding token profile; and transmitting the updated transaction message via the payment network.

### FIELD

The present disclosure relates to the transmitting of tokenized data, and perhaps more specifically the inclusion of tokenized data in an interchange message and transmission thereof using a payment network for additional security and for use of an established, secure communication network.

### BACKGROUND

Data is often transmitted from one party to another for a variety of reasons. In some instances, data may be transmitted for the identification of a party, such as in a transaction. For example, in a payment transaction, an account number corresponding to a transaction account being used to fund the transaction may be transmitted to identify the payment account from which funds are to be withdrawn. In another example, in a transaction on a college campus, a student wishing to use a campus service may scan their student identification card, and a student number or other data encoded thereon transmitted to identify if the student has sufficient privileges to use the service.

Due to the dangers to each of the parties involved, in payment transactions, transaction account numbers are often encrypted or tokenized in order to increase the security of the transaction and prevent fraud. However, in transactions that do not traditionally take place using payment network rails, such as in the example college transaction, the identification data is often unsecured, either in storage or during transmission. As a result, in such transactions, sensitive data may be at risk of being compromised. In instances where personal data may be used for identification, such as social security numbers, the potential dangers to such data being compromised can be extremely high.

Thus, there is a need for a technical solution to increase the security of the transmission of such data by using tokenization techniques and the added security and integrity of existing payment networks.

### SUMMARY

The present disclosure provides a description of systems and methods for transmitting tokenized data.

A method for transmitting tokenized data includes: storing, in a token database, a plurality of token profiles, wherein each token profile includes data related to a tokenized data element including at least a token, a data value, and an associated data element; receiving, by a receiving device, a transaction message via a payment network, wherein the transaction message is formatted pursuant to one or more standards governing the interchange of transaction messages and includes data in one or more data elements reserved for private use in the one or more standards, and where the data included in each of the one or more data elements is encrypted using a public key; decrypting, by a processing device, the encrypted data included in each of the one or more data elements using a private key corresponding to the public key to obtain decrypted data; identifying, for each of the one or more data elements, a corresponding token profile where the included associated data element is the respective one or more data element and where the included data value corresponds to the decrypted data for the respective one or more data element; updating, by the processing device, the transaction message by replacing the encrypted data included in each of the one or more data elements with the token included in the identified corresponding token profile; and transmitting, by a transmitting device, the updated transaction message via the payment network.

Another method for transmitting tokenized data includes: storing, in a token database, a plurality of token profiles, wherein each token profile includes data related to a tokenized data element including at least a token, a data value, and an associated data element; receiving, by a receiving device, a transaction message via a payment network, wherein the transaction message is formatted pursuant to one or more standards governing the interchange of transaction messages and includes data in one or more data elements reserved for private use in the one or more standards; identifying, for each of the one or more data elements, a corresponding token profile where the included associated data element is the respective one or more data element and where the included token corresponds to the data included in the respective one or more data element; updating, by a processing device, the transaction message by replacing the data included in each of the one or more data elements with the data value included in the identified corresponding token profile; and transmitting, by a transmitting device, the updated transaction message via the payment network.

A system for transmitting tokenized data includes a token database, a receiving device, a processing device, and a transmitting device. The token database is configured to store a plurality of token profiles, wherein each token profile includes data related to a tokenized data element including at least a token, a data value, and an associated data element. The receiving device is configured to receive a transaction message via a payment network, wherein the transaction message is formatted pursuant to one or more standards governing the interchange of transaction messages and includes data in one or more data elements reserved for private use in the one or more standards, and where the data included in each of the one or more data elements is encrypted using a public key. The processing device is configured to: decrypt the encrypted data included in each of the one or more data elements using a private key corresponding to the public key to obtain decrypted data; identify, for each of the one or more data elements, a corresponding token profile where the included associated data element is the respective one or more data element and where the included data value corresponds to the decrypted data for the respective one or more data element; and update the transaction message by replacing the encrypted data included in each of the one or more data elements with the token included in the identified corresponding token profile. The transmitting device is configured to transmit the updated transaction message via the payment network.

Another system for transmitting tokenized data includes a token database, a receiving device, a processing device, and a transmitting device. The token database is configured to store a plurality of token profiles, wherein each token profile includes data related to a tokenized data element including at least a token, a data value, and an associated data element. The receiving device is configured to receive a transaction message via a payment network, wherein the transaction message is formatted pursuant to one or more standards governing the interchange of transaction messages and includes data in one or more data elements reserved for private use in the one or more standards. The processing device is configured to: identify, for each of the one or more data elements, a corresponding token profile where the included associated data element is the respective one or more data element and where the included token corresponds to the data included in the respective one or more data element; and update the transaction message by replacing the data included in each of the one or more data elements with the data value included in the identified corresponding token profile. The transmitting device is configured to transmit the updated transaction message via the payment network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for transmitting tokenized data in accordance with exemplary embodiments.

FIG. 2 is a block diagram illustrating the processing server of FIG. 1 for transmitting tokenized data in accordance with exemplary embodiments.

FIG. 3 is a flow diagram illustrating a process for generating tokens and transmitting tokenized data using the system of FIG. 1 in accordance with exemplary embodiments.

FIG. 4 is a flow diagram illustrating a process for identifying and transmitting tokenized data using the system of FIG. 1 in accordance with exemplary embodiments.

FIG. 5 is a flow chart illustrating a process for transmitting tokenized data using the processing server of FIG. 2 in accordance with exemplary embodiments.

FIGS. 6 and 7 are flow charts illustrating exemplary methods for transmitting tokenized data in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### System for Transmitting Tokenized Data

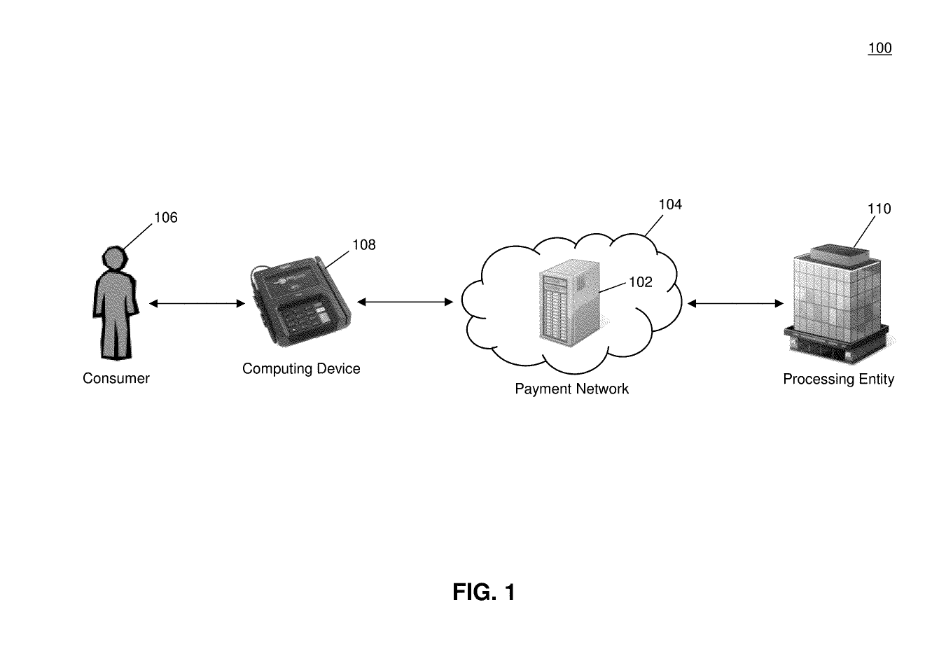

FIG. 1 illustrates a system 100 for transmitting tokenized data included in a transaction message and transmitted across a payment network.

The system 100 may include a processing server 102. The processing server 102, discussed in more detail below, may be part of a payment network 104 and may be configured to facilitate the secure exchange of data from a consumer 106 to a processing entity 110 via the payment network 104.

The consumer 106 may provide data to a computing device 108. The computing device 108 may be a point of sale device or other type of computing device configured to communicate with the payment network 104 and transmit data. The computing device 108 may receive the data from the consumer 106, such as by reading data encoded in a magnetic strip of a card, receiving data via near field communication from another computing device, receiving data input via one or more input devices, etc. The computing device 108 may then transmit the data to the payment network 104 in a transaction message, which may route the data to the processing server 102.

As discussed in more detail below, the data transmitted by the computing device 108 may be a data value for which tokenization is required. In such an instance, the processing server 102 may generate a token corresponding to the data value and may return the token to the computing device 108. The token may be provided to the computing device 108 and/or consumer 106 for future use. The processing server 102 may transmit the data value to the processing entity 110 in the transaction message using the payment network 104. The processing entity 110 may then use the data value accordingly and return a response transaction message to the processing server 102 via the payment network 104.

The processing server 102 may then exchange the data value for the generated token, and forward the response transaction message with the token included and data value removed to the computing device 108. In future transactions, the computing device 108 may transmit the token instead of the data value to the payment network 104 in the transaction message. In such instances, the processing server 102 may exchange the token for the corresponding data value prior to forwarding of the transaction message to the processing entity 110. In these cases, the computing device 108 may never be in possession of the data value, and may instead use only the corresponding token.

In an example, the computing device 108 may be part of a computing system at a university. When a new student is registered at the university, the university may provide identification data associated with the student, such as a name, date of birth, social security number, street address, phone number, etc., to the payment network 104. A token may be generated by the processing server 102 that corresponds to the data, and may be returned to the university. The university may then issue an identification card to the new student that is encoded with the token, but includes none of the personal information associated with the student or provided to the payment network 104. In such an example, the student may use the identification card in future transactions with the university or other associated entities, such as at an affiliate restaurant on or near campus, which may use the token. Thus, if the card were to be compromised, a nefarious party may receive the token, but the personal information of the student would be unavailable.

By using the methods and systems disclosed herein for transmitting tokenized data, the processing server 102 may therefore provide for the secure transmission of data using existing payment network 104 infrastructure and standards governing the interchange of transaction messages. By tokenizing data and exchanging tokens for corresponding data values during the transaction process, the processing server 102 may be able to facilitate transactions where the computing device 108 does not possess the protected data values, and without processing entities 110 being required to modify existing systems as the data values are still used at the processing entity 110. The result is a system that may be of higher security, higher efficiency, and higher convenience that existing systems for the exchange of data.

### Processing Server

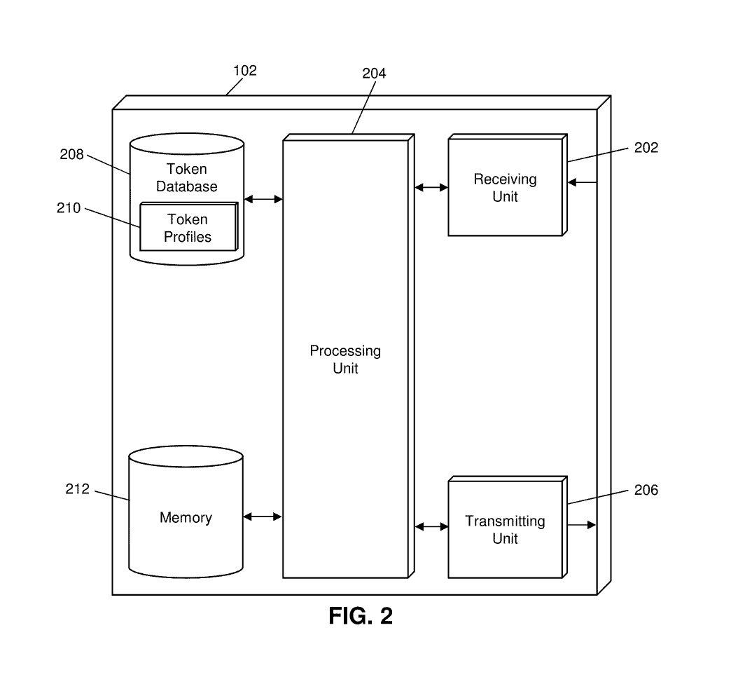

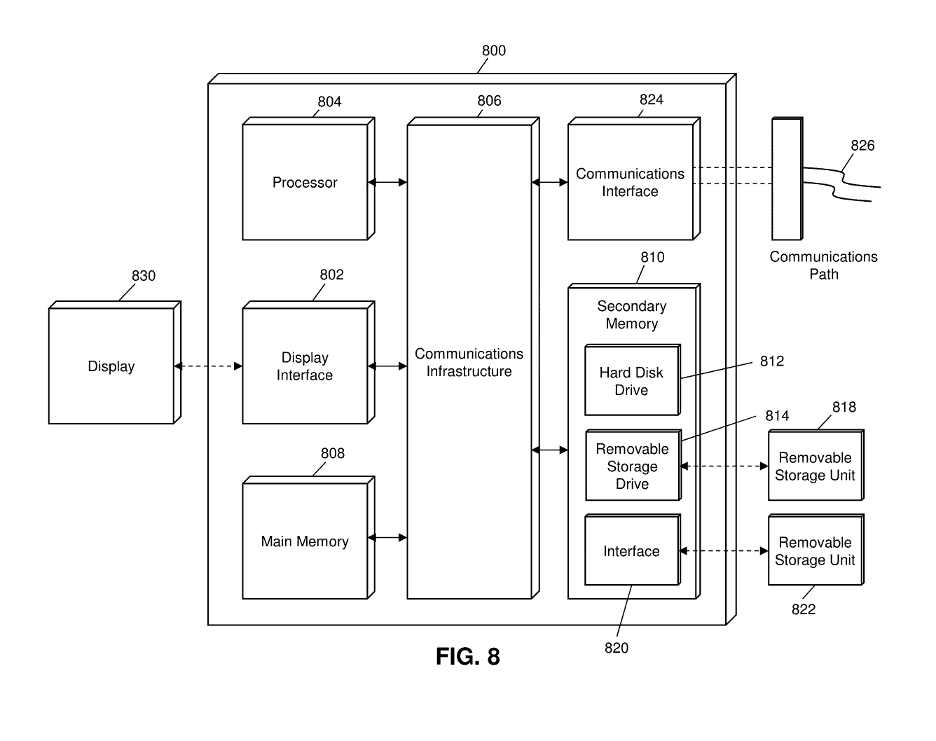

FIG. 2 illustrates an embodiment of the processing server 108 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving unit 202. The receiving unit 202 may be configured to receive data over one or more networks via one or more network protocols. The processing server 102 may be configured to receive transaction messages via the payment network 104. The transaction messages may be formatted pursuant to one or more standards governing the interchange of transaction messages. For instance, in one embodiment, transaction messages received by the receiving unit 202 may be formatted pursuant to the International Organization for Standardization's ISO 8583 standard. The receiving unit 202 may receive transaction messages and response transaction messages from the computing device 108 and processing entity 110. Transaction messages and response transaction messages may include data values and/or tokens in one or more data elements.

The processing server 102 may also include a processing unit 204. The processing unit 204 may be configured to perform the functions of the processing server 102 as discussed herein as will be apparent to persons having skill in the relevant art. The processing unit 204 may be configured to exchange data values in received transaction messages and response transaction messages for tokens. Data values may be exchanged for tokens using data stored in a token database 208.

The token database 208 may be configured to store a plurality of token profiles 210. Each token profile 210 may include data related to a tokenized data element including at least a token, a data value, and an associated data element. The token may be a random number, pseudo-random number, or other suitable type of generated and/or identified value suitable for use in performing the functions discussed herein. The data value may be a value that is to be replaced by the token, such as personal data or account data, such as associated with the consumer 106 or a transaction account. The data value may be, for example, a name, street address, phone number, e-mail address, username, social security number, tax identification number, medical information and healthcare issuance identification, etc.

It will be apparent to persons having skill in the relevant art that, although “data value” is generally used herein to indicate the data being protected and “token” is generally used to indicate the generated value that replaces the data value, the terms may be interchangeable provided that one of the elements corresponds to the value being protected and the other element corresponds to the generated value used to replace the protected value. For example, in some instances, the data value may be the generated random or pseudo-random number, and the token may be the value that is replaced by the data value in exchanges between the computing device 108 and the payment network 104.

The associated data element stored in each token profile 210 may be the data element in a transaction message that is to include the corresponding token or data value. The data element may be a data element that is reserved for private use in one of the one or more standards governing the interchange of transaction messages. For instance, the associated data element for a token profile 210 may be data field 61, 62, or 63 in instances where a transaction messages is formatted pursuant to ISO 8583.

The processing unit 204 may be configured to use the data included in the token profiles 210 to exchange data values for tokens and tokens for data values in received transaction messages and transaction response messages. For instance, if a destination of the transaction message or response transaction message is the computing device 108, the processing unit 204 may exchange any included data values for tokens, such as by identifying token profiles 210 that include data values included in indicated associated data elements in the transaction messages and exchanging them for the respective tokens. If a destination of a transaction message or response transaction message is the processing entity 110, then tokens may be exchanged for corresponding data values.

The processing unit 204 may also be configured to generate tokens and token profiles 210. For instance, if a transaction message is received from the computing device 108 that includes a data value for which no token corresponds, the processing unit 204 may generate a token to correspond with the data value and may generate a token profile 210 that includes the data value, generated token, and the data element in the transaction message that includes the data value, and store the generated token profile 210 in the token database 208. In some embodiments, the transaction message may indicate if a token should be generated for an included data value, such as by a flag included in the transaction message, by the data value included in a data element that is used to store tokenized data, etc.

The processing server 102 may also include a transmitting unit 206. The transmitting unit 206 may be configured to transmit data over one or more networks via one or more network protocols. The transmitting unit 206 may be configured to transmit transaction messages and response transaction messages over the payment network 104 to the computing device 108 and processing entity 110. The transmitting unit 206 may also be configured to transmit generated tokens to the computing device 108 or an associated entity, such as in instances where a token is newly generated and/or identified for a data value included in a transaction message received from the computing device 108.

The processing server 102 may further include a memory 212. The memory 212 may be configured to store data suitable for performing the functions of the processing server 102 disclosed herein. For example, the memory 212 may include one or more rules and/or algorithms for the replacement of data values with tokens, rules and/or algorithms for the generation of tokens, and other data that will be apparent to persons having skill in the relevant art.

### Processes for Transmitting Tokenized Data

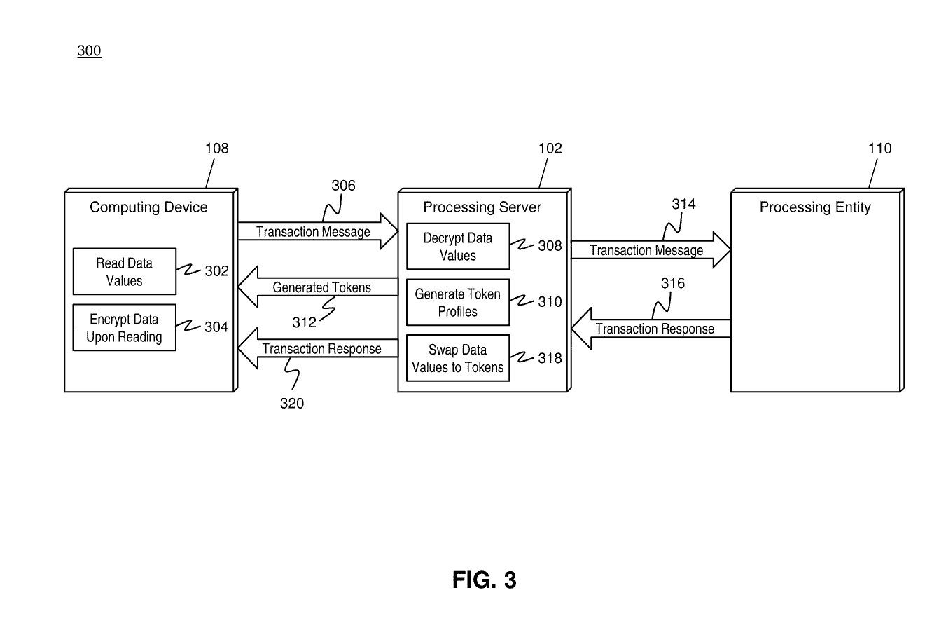

FIG. 3 illustrates a process 300 for the generation of a token and transmission of tokenized data using the system 100.

In step 302, the computing device 108 may read one or more data values, such as from a card presented by the consumer 106 for use in a transaction with the processing entity 110. In step 304, the computing device 108 may encrypt the data values upon reading such that the computing device 108 may not be in possession of unencrypted data values. The data values may be encrypted using a public key, such as one provided to the computing device 108 by the payment network 104 and/or processing server 102. In step 306, the computing device 108 may transmit a transaction message to the processing server 102 over the payment network 104. The transaction message may be formatted pursuant to one or more standards governing the interchange of transaction messages and may include the encrypted data values in one or more data elements reserved for private use in the governing standard(s).

The receiving unit 202 of the processing server 102 may receive the transaction message, and, in step 308, the processing unit 204 of the processing server 102 may decrypt the encrypted data values using a private key that corresponds to the public key used by the computing device 108. The private key may be stored, for example, in the memory 212 of the processing server 102. In step 310, the processing unit 204 may generate token profiles 210 for each of the decrypted data values and store the generated token profiles 210 in the token database 208. In step 312, the transmitting unit 206 of the processing server 102 may transmit the generated tokens that correspond to the decrypted data values to the computing device 108. In some embodiments, the generated tokens may be transmitted using the payment network 104.

In step 314, the transmitting unit 206 may forward the transaction message to the processing entity 110 using the payment network 104. The processing entity 110 may then perform actions based on the transaction message and, in step 316, return a transaction response message to the processing server 102 using the payment network 104. In step 318, the processing unit 204 may replace the data values included in the transaction response message with the corresponding tokens included in the respective token profiles 210. In step 320, the transmitting unit 206 may forward the transaction response message with the tokens to the computing device 108. The computing device 108 may then act accordingly based on the transaction response.

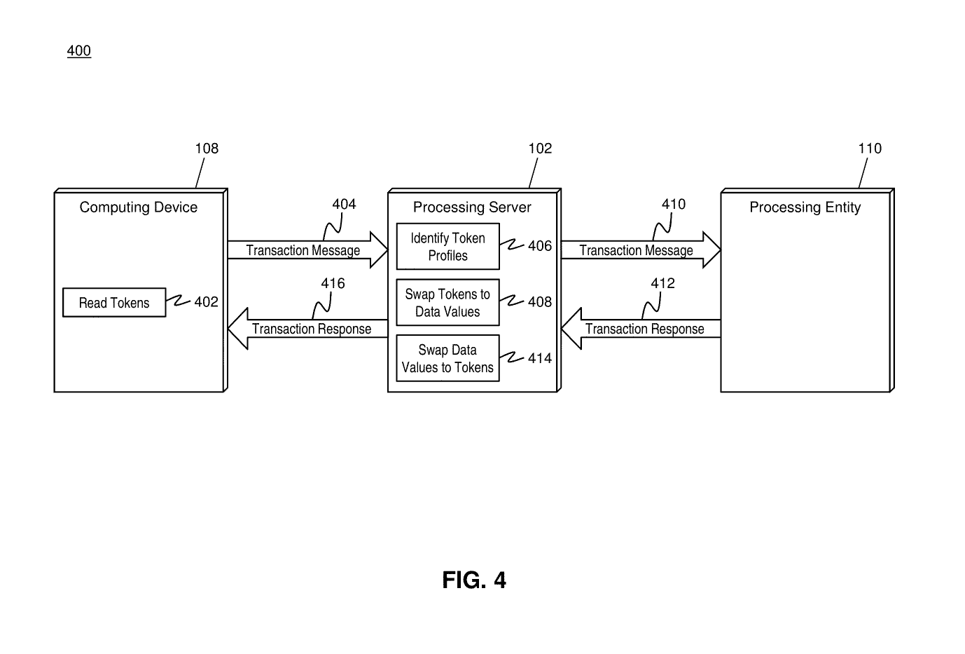

FIG. 4 illustrates a process 400 for the transmission of tokenized data using the system 100 where tokens have been previously generated.

In step 402, the computing device 108 may read one or more tokens, such as from a card presented by the consumer 106, via near field communication with another computing device (e.g., a mobile communication device associated with the consumer 106), or other suitable method. In step 404, the computing device 108 may submit a transaction message to the processing server 102 that is formatted pursuant to the one or more standards governing the interchange of the transaction message and that includes the read tokens in associated data elements.

The receiving unit 202 of the processing server 102 may receive the transaction message via the payment network 104, and, in step 406, the processing unit 204 may identify token profiles 210 in the token database 208 that include the tokens and the associated data elements. In step 408, the processing unit 204 may replace the tokens in the transaction message with the corresponding data values included in the identified token profiles 210. In step 410, the transmitting unit 206 of the processing server 102 may forward the transaction message with the included data values to the processing entity 110 via the payment network 104.

In step 412, the processing entity 110 may return a transaction response message to the processing server 102 using the payment network 104. In step 414, the processing unit 204 may swap the tokens back in for the data values. In step 416, the transmitting unit 206 may forward the transaction response message to the computing device 108 via the payment network 104 with the tokens included and data values removed.

### Process for Generating Tokens and Transmitting Tokenized Data

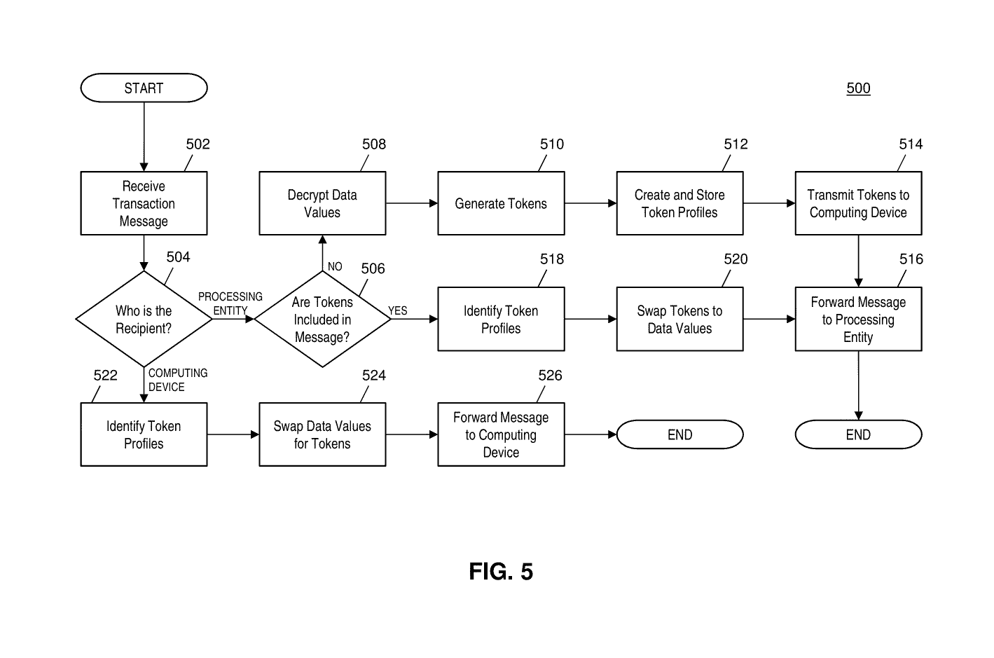

FIG. 5 illustrates a process 500 of the processing server 102 for generating tokens and exchanging transaction messages that include tokenized data.

In step 502, the receiving unit 202 of the processing server 102 may receive a transaction message. The transaction message may be formatted pursuant to one or more standards governing the interchange of transaction messages and may include at least an indicated recipient, and may also include one or more tokens or data values in data elements reserved for private use pursuant to the standards. In step 504, the processing unit 204 of the processing server 102 may determine who the recipient of the message is based on the data included in or accompanying the transaction message.

If the recipient of the message is the processing entity 110, then, in step 506, the processing unit 204 may determine if the data elements in the transaction message include tokens. If the data elements do not include tokens, and therefore include data values, then, in step 508, the processing unit 204 may decrypt the data values using a private key. In step 510, the processing unit 204 may generate and/or identify a token for each of the data values. Methods for generation of a token corresponding to a data value will be apparent to persons having skill in the relevant art.

In step 512, the processing unit 204 may create a token profile 210 for each generated token including the token, the corresponding data value, and the associated data element in which the data value was transmitted, and may store the created token profiles 210 in the token database 208. In step 514, the transmitting unit 206 of the processing server 102 may transmit the generated tokens to the computing device 108, such as for use in future transaction messages. In step 516, the transmitting unit 206 may forward the transaction message to the processing entity 110 using the payment network 104.

If, in step 506, the processing unit 204 determines that tokens are included in the transaction message, then, in step 518, the processing unit 204 may identify corresponding token profiles 210 in the token database 208. The corresponding token profiles 210 may be token profiles 210 that include the token and include an associated data element that corresponds to the data element in the transaction message in which the respective token was stored. In step 520, the processing unit 204 may swap the tokens in the data elements in the transaction message for the corresponding data value included in the identified token profiles 210. In step 516, the transmitting unit 206 may forward the transaction message to the processing entity 110 using the payment network 104.

If the intended recipient for the transaction message received by the receiving unit 202 is determined to be, in step 504, the computing device 108, then, in step 522 of the process 500, the processing unit 204 may identify token profiles 210 in the token database 208 that correspond to the data values included in the transaction message. The identified token profiles 210 may be token profiles 210 that include the data values and include an associated data element that corresponds to the data element in the transaction message in which the respective data value was stored. In step 524, the processing unit 204 may swap the data values in the data elements in the transaction message for the corresponding token included in the identified token profiles 210. In step 526, the transmitting unit 205 may forward the transaction message to the computing device 108 using the payment network 104.

### First Exemplary Method for Transmitting Tokenized Data

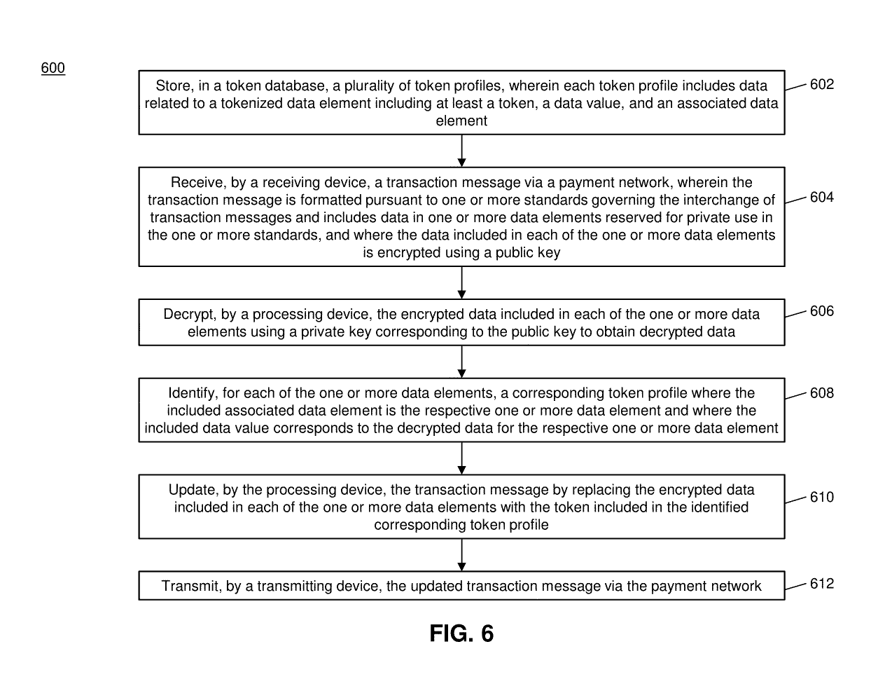

FIG. 6 illustrates a method 600 for transmitting tokenized data using transaction messages and a payment network.

In step 602, a plurality of token profiles (e.g., token profiles 210) may be stored in a token database (e.g., the token database 208), wherein each token profile 210 includes data related to a tokenized data element including at least a token, a data value, and an associated data element. In some embodiments, the data value and token included in each token profile are one of: a data value associated with a consumer (e.g., the consumer 106) or consumer account and a random or pseudo-random number.

In step 604, a transaction message may be received by a receiving device (e.g., the receiving unit 202) via a payment network (e.g., the payment network 104), wherein the transaction message is formatted pursuant to one or more standards governing the interchange of transaction messages and includes data in one or more data elements reserved for private use in the one or more standards, and where the data included in each of the one or more data elements is encrypted using a public key. In one embodiment, the one or more standards may include at least the ISO 8583 standard.

In step 606, the encrypted data included in each of the one or more data elements may be decrypted by a processing device (e.g., the processing unit 204) using a private key corresponding to the public key to obtain decrypted data. In step 608, a corresponding token profile 210 may be identified for each of the one or more data elements where the included associated data element is the respective one or more data elements and where the included data value corresponds to the decrypted data for the respective one or more data element. In step 610, the transaction message may be updated by the processing device 204 by replacing the encrypted data included in each of the one or more data elements with the token included in the identified corresponding token profile 210.

In step 612, the updated transaction message may be transmitted by a transmitting device (e.g., the transmitting unit 206) via the payment network 104. In some embodiments, the transaction message may be received from a first entity and the updated transaction message may be transmitted to a second entity. In one embodiment, the method 600 may further include: generating, by the processing device 204, a token for each of the one or more data elements, wherein the token is a random number or pseudo-random number; generating, by the processing device 204, a token profile 210 for each of the one or more data elements, wherein each generated token profile 210 includes the generated token, the decrypted data as the data value, and the respective data element as the associated data element; and storing, in the token database 208, each generated token profile 210.

### Second Exemplary Method for Transmitting Tokenized Data

In step 702, a plurality of token profiles (e.g., token profiles 210) may be stored in a token database (e.g., the token database 208), wherein each token profile 210 includes data related to a tokenized data element including at least a token, a data value, and an associated data element. In some embodiments, the data value and token included in each token profile 210 may be one of: a data value associated with a consumer (e.g., the consumer 106) or consumer account and a random or pseudo-random number.

In step 704, a transaction message may be received by a receiving device (e.g., the receiving unit 202) via a payment network (e.g., the payment network 104), wherein the transaction message is formatted pursuant to one or more standards governing the interchange of transaction messages and includes data in one or more data elements reserved for private use in the one or more standards. In one embodiment, the one or more standards may include at least the ISO 8583 standard.

In step 706, a corresponding token profile 210 may be identified for each of the one or more data elements where the included associated data element is the respective one or more data element and where the included token corresponds to the data included in the respective one or more data element. In step 708, the transaction message may be updated by a processing device (e.g., the processing unit 204) by replacing the data included in each of the one or more data elements with the data value included in the identified corresponding token profile 210.

In step 710, the updated transaction messaged may be transmitted by a transmitting device (e.g., the transmitting unit 206) via the payment network 104. In some embodiments, the method 700 may further include encrypting, by the processing device 204, the data value included in each of the one or more data elements using a public key prior to transmitting the updated transaction message. In one embodiment, the transaction message may be received from a first entity, and the updated transaction message may be transmitted to a second entity.

### Computer System Architecture

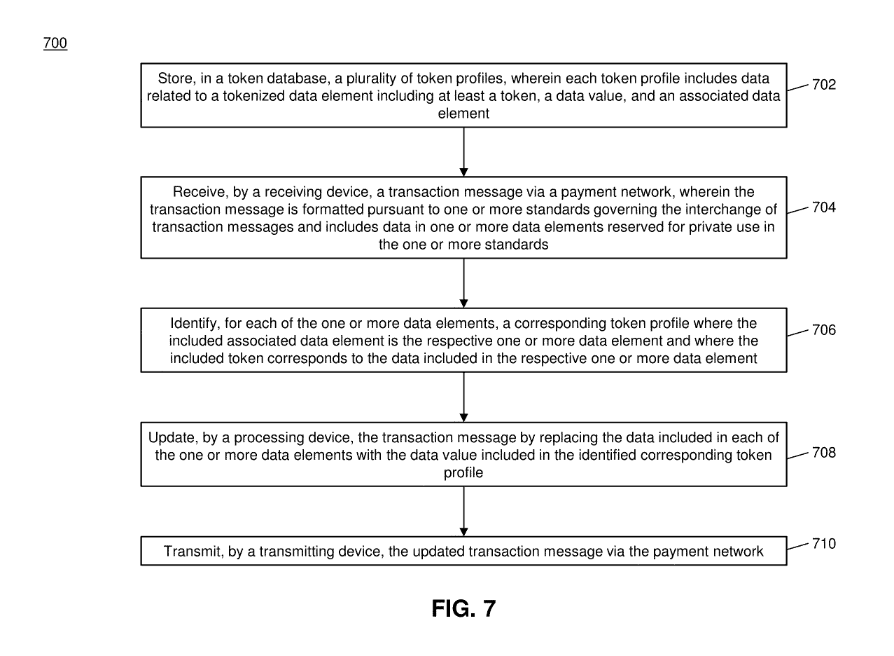

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for transmitting tokenized data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for transmitting tokenized data, comprising:
storing, in a token database, a plurality of token profiles, wherein each token profile includes data related to a tokenized data element including at least a token, a data value, and an associated data element;
receiving, by a receiving device, a transaction message via a payment network, wherein the transaction message is formatted pursuant to one or more standards governing the interchange of transaction messages and includes data in one or more data elements reserved for private use in the one or more standards, and where the data included in each of the one or more data elements is encrypted using a public key;
decrypting, by a processing device, the encrypted data included in each of the one or more data elements using a private key corresponding to the public key to obtain decrypted data;
identifying, for each of the one or more data elements, a corresponding token profile where the included associated data element is the respective one or more data element and where the included data value corresponds to the decrypted data for the respective one or more data element;
updating, by the processing device, the transaction message by replacing the encrypted data included in each of the one or more data elements with the token included in the identified corresponding token profile; and
transmitting, by a transmitting device, the updated transaction message via the payment network.

2. The method of claim 1, wherein the one or more standards includes at least the ISO 8583 standard

3. The method of claim 1, wherein the transaction message is received from a first entity, and wherein the updated transaction message is transmitted to a second entity.

4. The method of claim 1, wherein the data value and token included in each token profile are one of: a data value associated with a consumer or consumer account and a random or pseudo-random number.

5. The method of claim 1, further comprising:
generating, by the processing device, a token for each of the one or more data elements, wherein the token is a random number or pseudo-random number;
generating, by the processing device, a token profile for each of the one or more data elements, wherein each generated token profile includes the generated token, the decrypted data as the data value, and the respective data element as the associated data element; and
storing, in the token database, each generated token profile.

6. A method for transmitting tokenized data, comprising:
storing, in a token database, a plurality of token profiles, wherein each token profile includes data related to a tokenized data element including at least a token, a data value, and an associated data element;
receiving, by a receiving device, a transaction message via a payment network, wherein the transaction message is formatted pursuant to one or more standards governing the interchange of transaction messages and includes data in one or more data elements reserved for private use in the one or more standards;
identifying, for each of the one or more data elements, a corresponding token profile where the included associated data element is the respective one or more data element and where the included token corresponds to the data included in the respective one or more data element;
updating, by a processing device, the transaction message by replacing the data included in each of the one or more data elements with the data value included in the identified corresponding token profile; and
transmitting, by a transmitting device, the updated transaction message via the payment network.

7. The method of claim 6, wherein the one or more standards includes at least the ISO 8583 standard.

8. The method of claim 6, further comprising:
encrypting, by the processing device, the data value included in each of the one or more data elements using a public key prior to transmitting the updated transaction message.

9. The method of claim 6, wherein the transaction message is received from a first entity, and wherein the updated transaction message is transmitted to a second entity.

10. The method of claim 6, wherein the data value and token included in each token profile are one of: a data value associated with a consumer or consumer account and a random or pseudo-random number.

11. A system for transmitting tokenized data, comprising:
a token database configured to store a plurality of token profiles, wherein each token profile includes data related to a tokenized data element including at least a token, a data value, and an associated data element;
a receiving device configured to receive a transaction message via a payment network, wherein the transaction message is formatted pursuant to one or more standards governing the interchange of transaction messages and includes data in one or more data elements reserved for private use in the one or more standards, and where the data included in each of the one or more data elements is encrypted using a public key;
a processing device configured to
decrypt the encrypted data included in each of the one or more data elements using a private key corresponding to the public key to obtain decrypted data,
identify, for each of the one or more data elements, a corresponding token profile where the included associated data element is the respective one or more data element and where the included data value corresponds to the decrypted data for the respective one or more data element, and
update the transaction message by replacing the encrypted data included in each of the one or more data elements with the token included in the identified corresponding token profile; and
a transmitting device configured to transmit the updated transaction message via the payment network.

12. The system of claim 11, wherein the one or more standards includes at least the ISO 8583 standard

13. The system of claim 11, wherein the transaction message is received from a first entity, and wherein the updated transaction message is transmitted to a second entity.

14. The system of claim 11, wherein the data value and token included in each token profile are one of: a data value associated with a consumer or consumer account and a random or pseudo-random number.

15. The system of claim 11, wherein the processing device is further configured to
generate a token for each of the one or more data elements, wherein the token is a random number or pseudo-random number,
generate a token profile for each of the one or more data elements, wherein each generated token profile includes the generated token, the decrypted data as the data value, and the respective data element as the associated data element, and
store, in the token database, each generated token profile.

16. A system for transmitting tokenized data, comprising:
a token database configured to store a plurality of token profiles, wherein each token profile includes data related to a tokenized data element including at least a token, a data value, and an associated data element;
a receiving device configured to receive a transaction message via a payment network, wherein the transaction message is formatted pursuant to one or more standards governing the interchange of transaction messages and includes data in one or more data elements reserved for private use in the one or more standards;
a processing device configured to
identify, for each of the one or more data elements, a corresponding token profile where the included associated data element is the respective one or more data element and where the included token corresponds to the data included in the respective one or more data element, and
update the transaction message by replacing the data included in each of the one or more data elements with the data value included in the identified corresponding token profile; and
a transmitting device configured to transmit the updated transaction message via the payment network.

17. The system of claim 16, wherein the one or more standards includes at least the ISO 8583 standard

18. The system of claim 16, wherein the processing device is further configured to encrypt the data value included in each of the one or more data elements using a public key prior to transmitting the updated transaction message.

19. The system of claim 16, wherein the transaction message is received from a first entity, and wherein the updated transaction message is transmitted to a second entity.

20. The system of claim 16, wherein the data value and token included in each token profile are one of: a data value associated with a consumer or consumer account and a random or pseudo-random number.
